(19) United States
(12) Patent Application Publication
(10) Pub. No.: US 2012/0199708 A1
(43) Pub. Date: Aug. 9, 2012

(54) WALL MOUNTABLE STORAGE

(75) Inventor: Lance Patrick Convey, Loganholme (AU)

(73) Assignee: THE GARAGE ORGANISERS PTY LTD, Capalaba, QU (AU)

(21) Appl. No.: 13/501,751

(22) PCT Filed: Oct. 13, 2010
(86) PCT No.: PCT/AU2010/001351

§ 371 Date: Apr. 13, 2012

(30) Foreign Application Priority Data
Oct. 13, 2009 (AU) 2009904953

(51) Int. Cl. A47F 5/08; B23P 11/00

(52) U.S. Cl. 248/201; 248/205.1; 29/428

(57) ABSTRACT

A mounting component for a wall mountable storage arrangement includes a plurality of elongate brackets that are fastenable to a wall. The brackets are connected end-to-end in a consecutive manner and are detachable from one another to permit variation of the number of connected brackets. Each bracket is configured to engage a storage panel to support the storage panel in an operative position, such that a number of storage panels on a wall can be varied by detaching an appropriate number of brackets.

### FIELD OF THE INVENTION

This invention relates to wall mountable storage. In particular, this invention relates to a mounting component for a wall mountable storage arrangement. The invention also relates to a wall mountable storage arrangement and to a kit for a wall mountable storage arrangement.

### BACKGROUND TO THE INVENTION

Wall mountable storage arrangements often include a storage panel or some other storage element that is mounted on to a wall. Mounting formations or such items as hooks and even nails are arranged on the element to permit items to be stored to be hung from, or otherwise attached to, the element.

A well-known problem with general storage, such as that which may be found in a household garage or shed or even in commercial storage areas such as workshops is the difficulty with storing a large number of items having different shapes and configurations.

A number of attempts have been made to address the problems associated with the storage of such items. These attempts have resulted in issues associated with such storage such as the inability of many existing storage arrangements to adapt in a simple fashion to different areas. For example, where it becomes desirable to expand a storage area, many existing storage arrangements are not particularly suited for such expansion.

Furthermore, where elements are fastened to a wall of a particular area, such fastening is often carried out by screwing or bolting the elements directly on to the wall. This can result in screw or bolt heads being visible or even protruding from the elements, which is often considered unsightly. Also, elements which have been fastened in such a way can be difficult and time-consuming to remove and replace, if necessary.

It is often desirable that storage arrangements be moved from one area to another, for example when a householder moves premises. Storage arrangements that have been bolted or screwed into position do not lend themselves to such transferral because not only is it time-consuming to unbolt such an arrangement, but also subsequent installation may require holes to be positioned in different locations.

When expanding a storage area by fastening further elements to the wall, it is necessary for the further elements to be aligned with the existing elements for aesthetic and even functional reasons in some cases. With existing storage arrangements, this can require a significant level of skill and therefore also be time consuming and costly.

Where the existing elements are relatively large or long, it may be necessary for the installer to have one or more assistants to support the elements while they are installed. Again this can add to installation costs.

### SUMMARY OF THE INVENTION

According to a first aspect of the invention, there is provided a mounting component for a wall mountable storage arrangement, the component comprising

a plurality of elongate brackets that are fastenable to a wall, the brackets being connected end-to-end in a consecutive manner and being detachable from one another to permit variation of the number of connected brackets, each bracket being configured to engage a storage panel to support the storage panel in an operative position, such that a number of storage panels on a wall can be varied by detaching an appropriate number of brackets.

The brackets may be configured to be fastened to a stud of a wall or directly to the structural components of a wall, such as bricks:

A number of the components can be fastened to the structure in a generally parallel manner depending on the length of the storage panels. It will be appreciated that when a number of the mounting components are fastened to a series of studs they are automatically arranged in a parallel manner with respect to each other.

In one embodiment the storage panels are elongate and are configured to be oriented in a substantially horizontal manner to span at least two of the components. Thus, a height of assembled storage panels can be adjusted by detaching said appropriate number of brackets.

Each bracket may include a base and spaced mounting formations projecting away from an operative front face of the base.

In one embodiment ends of adjacent bases may connect along a transverse score line, so that the bases can be detached at the scores lines by repetitive bending of contiguous brackets relative to each other about the score fine. This reduces the number of brackets to accommodate a reduced number of panels.

Each mounting formation may be generally L-shaped and may project substantially orthogonally from the front face of the base, to define a mounting formation gap between an operatively upwardly projecting leg of the mounting formation and the front face of the base.

The upwardly projecting leg of the mounting formation may be shaped to reduce the mounting formation gap progressively from a relatively wider mouth of the mounting formation gap to a narrower waist of the mounting formation gap. This facilitates a frictional fit of a complementary mounting formation of the panel to the bracket. The mounting formation may thus be a spring-like clip allowing the panel to be clipped on to the bracket.

According to a second aspect of the invention, there is provided a wall mountable storage arrangement that comprises

at least two of the mounting components as described above for fastening, in a substantially vertical and spaced manner to a structure such as a wall, with respective mounting formations of the components being aligned with each other; and

at least one of the storage panels for mounting on the mounting components to span the components such that the, or each, storage panel is substantially horizontal.

Each storage panel may include an elongate panel body with panel mounts that complement the mounting formations of associated brackets.

The panel mounts may include spaced slots defined in the panel body. A lip may project into each slot Thus, each slot may have a generally L-shaped transverse profile.

Each lip may have a transverse width that is wider than the waist of the mounting formation gap of the mounting formation, to facilitate a motional fit and thus clipping of the panel mounts into the mounting formations of the brackets.

The wall mountable storage arrangement may include a storage accessory that is mountable onto a front of the storage panel. The panel body may define longitudinally extending front carrier formations for engaging complementary formations of the storage accessories.

According to a third aspect of the invention, there is provided a kit for a wall mountable storage arrangement, the kit comprising

a number of mounting components as described above; and

at least one storage panel as described above.

The kit may also include at least one storage accessory for mounting on the storage panel.

According to a fourth aspect of the invention, there is provided a method of assembling a wall mountable storage arrangement on a wall, the method comprising the steps of:

fastening a number of mounting components, as described above, to the wall in a spaced, vertical manner; and

mounting at least one storage panel to the mounting components such that the storage panel spans the mounting components.

It will be convenient hereinafter to describe an embodiment of the invention in detail with reference to the accompanying drawings. The purpose of providing this detailed description is to instruct persons having an interest in the subject matter of the invention how to carry the invention into practical effect. However it is to be clearly understood that the specific nature of this detailed description does not supersede the generality of the preceding broad description or the appended claims.

### DESCRIPTION OF THE DRAWINGS

In the accompanying diagrammatic drawings:

FIG. 1 shows a room that includes a wall being equipped with a wall mountable storage arrangement, in accordance with the invention;

FIG. 2 is a three-dimensional view of a mounting component, in accordance with the invention, forming part of the wall mountable storage arrangement in FIG. 1;

FIG. 3 is a front view of two brackets of the mounting component being detached from each other at adjacent ends;

FIG. 4 is a side view of the bracket in FIG. 3;

FIG. 5 is a front view of the bracket in FIG. 4;

FIG. 6 is a three dimensional view of a storage panel forming part of the wall mountable storage arrangement;

FIG. 7 is a side view of the panel in FIG. 6;

FIG. 8 is a front view of the panel in FIG. 6; and

FIG. 9 is a side section view showing a wall and the mounting component mounted onto the wall, with a storage panel mounted on a bracket of the mounting component.

### DETAILED DESCRIPTION OF THE EMBODIMENTS SHOWN IN THE DRAWINGS

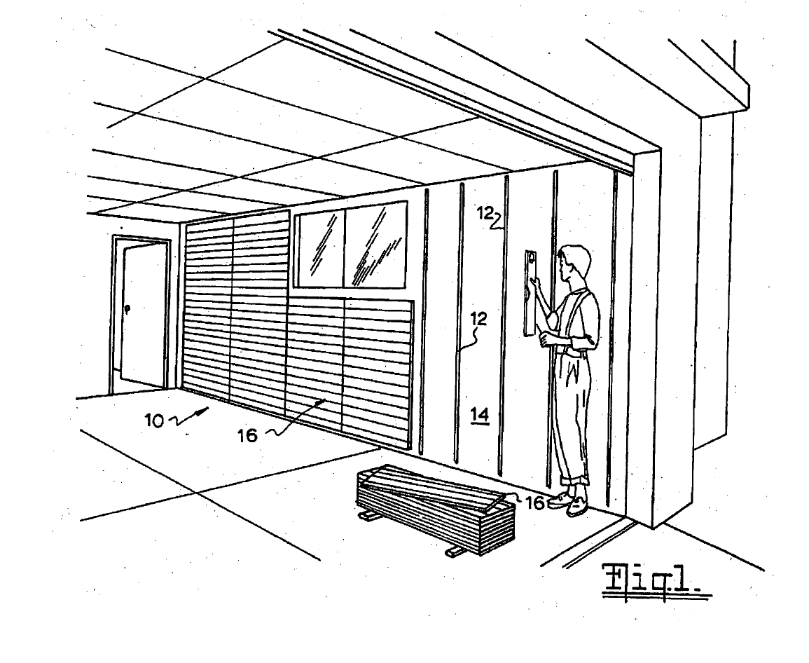

In FIG. 1 reference numeral 10 generally refers to a wall mountable storage arrangement, in accordance with the Invention. Broadly, the wall mountable storage arrangement 10 includes at least two elongate mounting components 12, also in accordance with the invention, fastenable to a wall 14 in a spaced, substantially vertical manner. At least one storage panel 16 is mountable on to the mounting components 12 to span the mounting components 12. The storage panel 16 can be configured to be in a substantially horizontal orientation when spanning the mounting components. The storage arrangement 10 can include at least one storage accessory 18 that can be carried by the panel 16.

The mounting components 12 can be fastened to respective studs of the wall 14, where appropriate, with the result that the components 12 are automatically in a spaced, substantially vertical configuration as can be seen in FIG. 1.

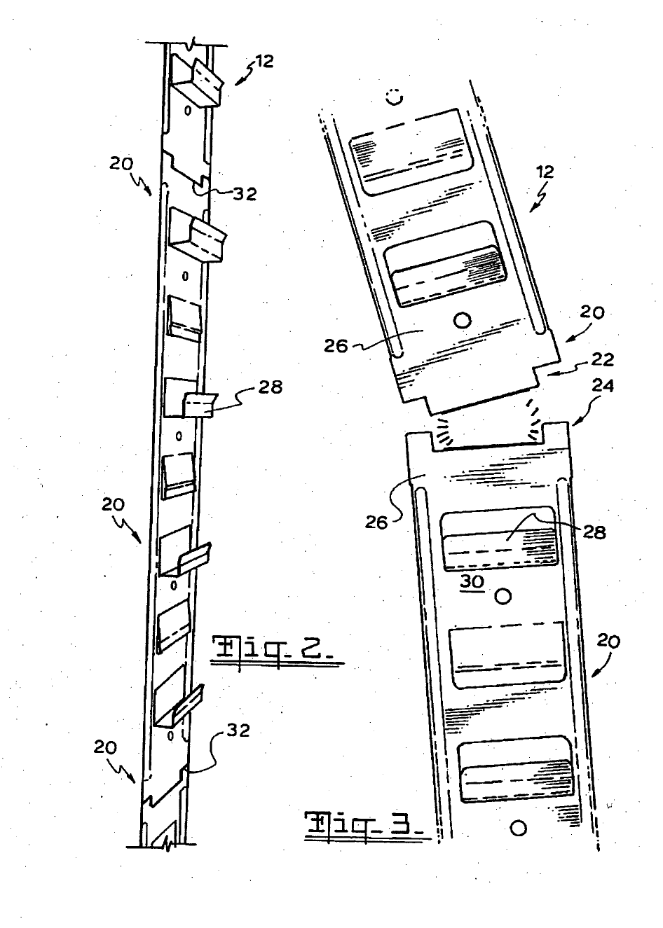

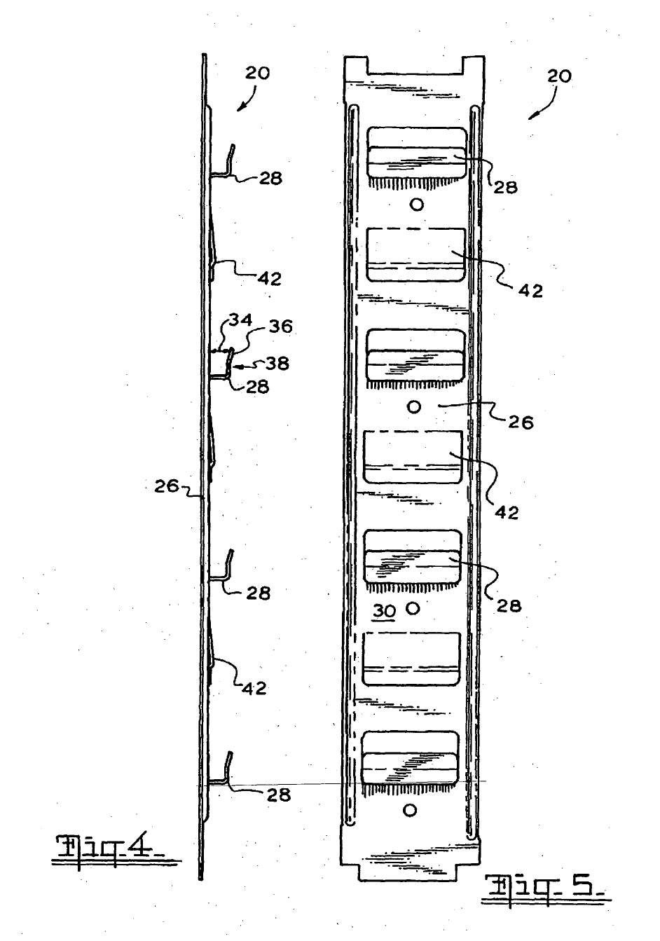

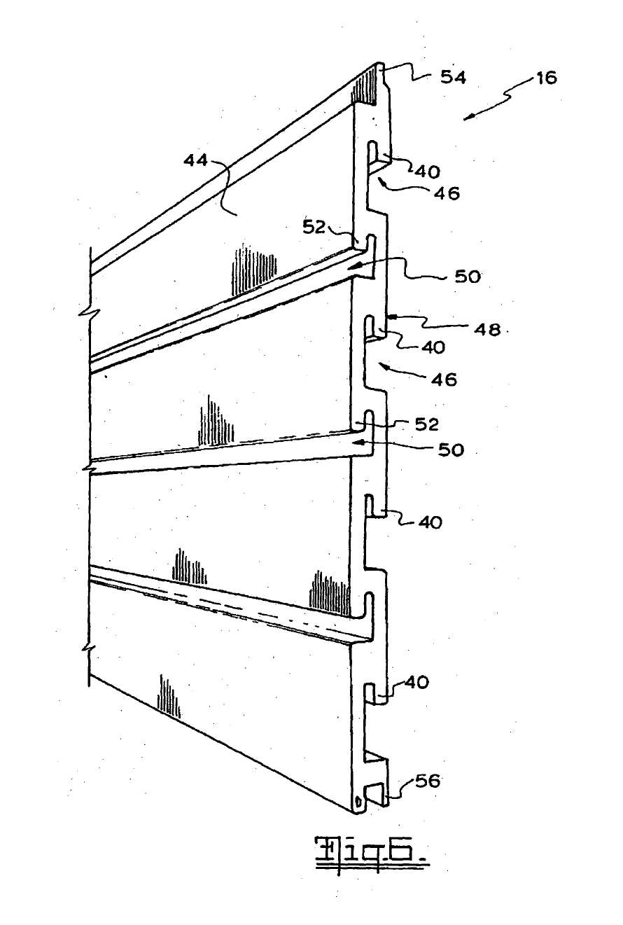

The mounting component 12 includes a plurality of elongate brackets 20 that are connected end-to-end in a consecutive manner. Adjacent ends 22, 24 of the bracket members 20 are connected to each other and are detachable from each other to truncate or shorten the mounting component 12 (FIGS. 2 and 3), to permit variation of the number of panels 16 to be mounted on the wall 14.

Each elongate bracket 20 includes a base 26 and a series of spaced mounting formations. 28 projecting, away from an operative front face 30 of the base 26 along the base 26.

In this example, the adjacent ends 22, 24 of adjacent bases 26 are connected along a transverse score line 32 (FIG. 2). The mounting component 12 is press-formed from an elongate metal alloy plate. The score lines 32 are formed during the press forming to create lines of weakness. Thus, bases 26 are detachable from each other by reciprocal repetitive bending of the bases 26. relative to. each other about the score fine 32, to remove unneeded brackets 20 from the mounting component 12 for mounting a fewer number of modular panels 16, where desired.

It will be appreciated that expansion can simply be by way of fastening a further mounting component 12 to the wall 16 in alignment with the existing installed mounting component 12. To that end, the ends 22, 24 define complementary nesting formations (FIG. 3) to facilitate alignment of a new mounting component 12 with an existing installed mounting component.

Each mounting formation 28 is generally L-shaped and projects orthogonally away from the front face 30 of the base 26, to define a mounting formation gap 34 between an upwardly projecting leg 36 of the L-shaped mounting formation 28 and the front face 30 of the base 26.

The upwardly projecting leg 36 of the L-shaped mounting formation 28 is shaped so that the mounting formation gap 34 progressively reduces in width from a relative wider mouth of the gap 34 to a narrower waist, at 38, of the gap. The narrower waist 38 facilitates a frictional fit or clipping of a complementary mounting formation 40 of the panel 16 in the gap 34.

The L-shaped mounting formation 28 is thus formed, shaped and sized to define a spring-like clip. In other words the upright leg 28 has a degree of flex to facilitate the frictional fit of the complementary panel mounting formation 40 of the panel 16 in the gap 34.

The base 26 also defines a plurality of panel face abutment formations in the form of generally rectangular tabs 42 that are pressed out from the base 26 so that they are slightly raised relative to the base 26 for abutting a rear face of the modular panel 16. These serve to ensure that the panels 16 are fitted to the mounting components 12 in a secure manner that is substantially free of play.

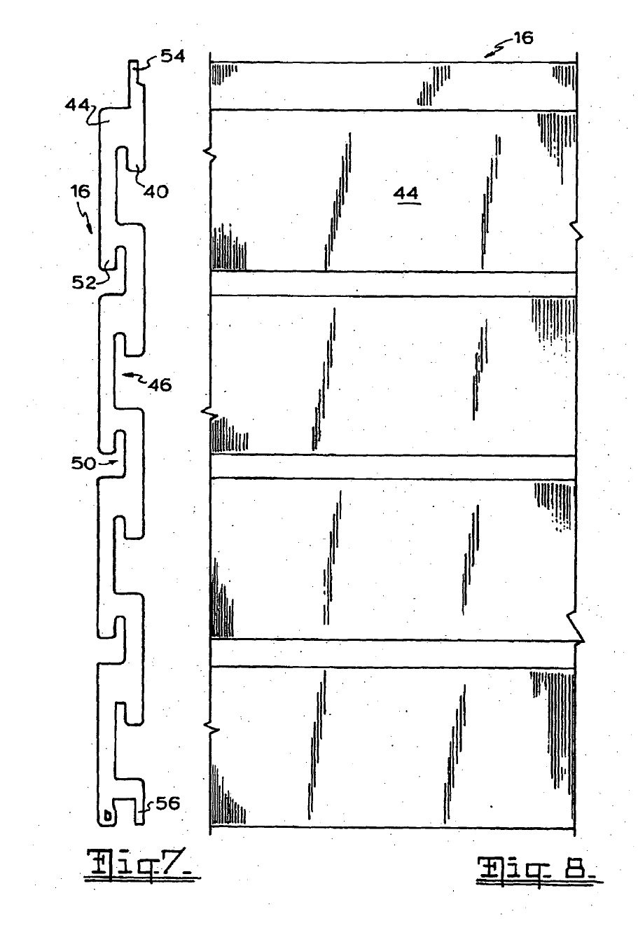

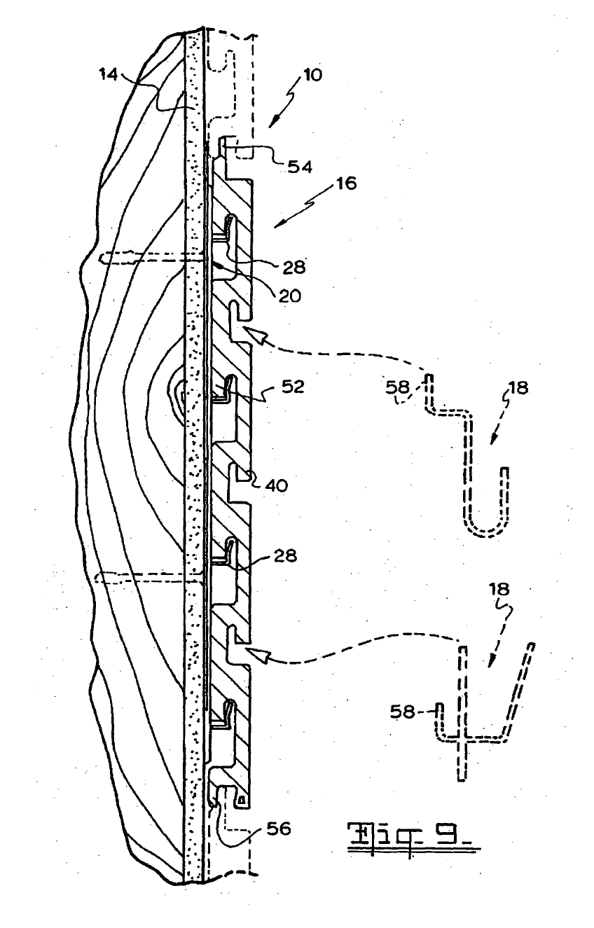

Each panel 16 includes an elongate panel body 44 (FIGS. 6 to 8) with panel mounts 40 that complement the mounting formations 28 of associated brackets 20. The mounting formations 40 are in the form of longitudinal lips that project into slots 46 from side edges, at 48. of the slots 46 respectively. Thus, the slots 46 have a generally L-shaped transverse profile. The lips 40 have a transverse width that is slightly wider than the waist of the gap, at 38, of the mounting formations 28, to facilitate clipping of the lip 40 into associated mounting formations 28.

Similarly, the panel 16 defines a plurality of longitudinally extending spaced front slots 50 with a configuration that is similar to the slots 46. Thus, longitudinal lips 52 project into the slots 50, so that the slots 50 have a generally L-shaped transverse cross section, for receiving complementarily shaped formations 58 of the storage accessories 18 such that the storage accessories 18 can be mounted on the panel 16 if desired.

Each panel 16 defines an elongate projection 54 on one operatively horizontal side and an elongate recess 56 on an opposite side so that the panels 16 can be nested with respect to each other to present a substantially uniform storage surface.

In use, if a user wishes to install the wall mountable storage arrangement 10 then a user obtains a kit that includes a plurality of the mounting components 12, panels 16, and storage accessories 18.

The user determines the number of modular panels 16 that are to be mounted onto the wall adjacent each other, and removes a required number of mounting brackets 20 from the mounting component 12 in the manner described above.

In this example, the truncated or shortened mounting components 12 are then fastened to studs of the wall 14 with suitable fasteners as shown in FIG. 9. It will be appreciated that the studs will determine the spacing of the components 12 and will result in the components being stored in a substantially vertical orientation. The mounting formations 26 of the respective mounting components are aligned with each other. As a result, the panels 16 are supported in a substantially horizontal manner.

The panels 16 are mounted onto the brackets 20 by sliding the lips 40 of the panels 16 into associated mounting formations 28 of the brackets 20.

The storage accessories 18 are then mounted onto the front of the panels 16 at desired positions.

The mounting component 12 can be originally manufactured for mounting a corresponding number of panels 16, for example it can include seven brackets 20 having lengths selected so that the mounting component 12 spans substantially the entire height of a wall of standard height. However, if a user wishes to mount a fewer number of panels 16, the unwanted brackets 20 can be removed from the mounting component so that the remainder of the brackets 20 corresponds with the fewer number of panels 16 that the user wishes to mount on to the wall 14. Also, if the user wishes to add panels 16 at a later date, further mounting components 12 can simply be fastened to the wall 14 in alignment with the existing installed components 12, in the manner described above.

Also, it is convenient to use mounting components 12 that include a number of brackets 20 that are connected to each other, in that the brackets do not have to be individually aligned horizontally with those of another mounting component 12. Rather, if the mounting components 12 are aligned with each other, then automatically their brackets 20 are also aligned. This can save time installing the brackets and can reduce the risk of misalignment of the brackets if they were to be aligned and mounted individually.

It will also be appreciated that removal of the panels 16 from the brackets 20 is a simple operation to be carried out by sliding the panels 16 out of the brackets 20. This facilitates re-location of the storage arrangement 10.

This invention finds application in a wall mountable storage arrangement for storing articles on a wall inside a storage structure such as a garage or shed in an organised fashion. At the same time however it is to be clearly understood that the invention is capable of broader application. For example, embodiments of the invention could be used for organised storage of articles on a wall inside a workshop, retail shops, children's play rooms, or the like.

Throughout the specification, including the claims, where the context permits, the term “comprising” and variants thereof such as “comprise” or “comprises” are to be interpreted as including the stated integer or integers without necessarily excluding any other integers.

It is to be understood that the above has been given only by way of illustrative example of the invention and that all such modifications and variations thereto, as would be apparent to persons skilled in the art, are deemed to. fall within the broad scope and ambit of the invention as is herein set forth.

1. A mounting component for a wall mountable storage arrangement, the component comprising;
a plurality of elongate brackets that are fastenable to a wall, the brackets being connected end-to-end in a consecutive manner and being detachable from one another to permit variation of the number of connected brackets, each bracket being configured to engage a storage panel to support the storage panel in an operative position, such that a number of storage panels on a wall can be varied by detaching an appropriate number of brackets.

2. A mounting component as claimed in claim 1, in which the brackets are configured to be fastened to a structural component of a wall, such as a stud.

3. A mounting component as claimed in claim 1, in which each bracket includes a base and spaced mounting formations projecting away from an operative front face of the base.

4. A mounting component as claimed in claim 3, in which ends of adjacent bases connect along a transverse score line, so that the bases can be detached at the scores lines by bending of contiguous brackets relative to each other about the score line to reduce the number of brackets to accommodate a reduced number of panels.

5. A mounting component as claimed in claim 3, in which each mounting formation is generally L-shaped and projects substantially orthogonally from the front face of the base, to define a mounting formation gap between an operatively upwardly projecting leg of the mounting formation and the front face of the base.

6. A mounting component as claimed in claim 5, in which the upwardly projecting leg of the mounting formation is shaped to reduce the mounting formation gap progressively from a relatively wider mouth of the mounting formation gap to a narrower waist of the mounting formation gap to facilitate a frictional fit of a complementary mounting formation of the panel to the bracket such that the mounting formation is a spring-like clip allowing the panel to be clipped on to the bracket.

7. A wall mountable storage arrangement that comprises:
at least two of the mounting components as claimed in claim 1 for fastening, in a substantially vertical and spaced manner, to a structure such as a wall; and
at least one storage panel for mounting on the mounting components to span the mounting components such that the, or each storage panel is substantially horizontal.

8. A wall mountable storage arrangement as claimed in claim 7 in which each bracket includes a base and spaced mounting formations projecting away from an operative front face of the base, with respective mounting formations of the components being aligned with each other.

9. A wall mountable storage arrangement as claimed in claim 8, in which each storage panel includes an elongate panel body with panel mounts that complement the mounting formations of associated brackets.

10. A wall mountable storage arrangement as claimed in claim 9, in which each bracket includes a base and spaced mounting formations projecting away from an operative front face of the base, in which each mounting formation is generally L-shaped and projects substantially orthogonally from the front face of the base, to define a mounting formation gap between an operatively upwardly projecting leg of the mounting formation and the front face of the base, in which the upwardly projecting leg of the mounting formation is shaped to reduce the mounting formation gap progressively from a relatively wider mouth of the mounting formation gap to a narrower waist of the mounting formation gap to facilitate a frictional fit of a complementary mounting formation of the panel to the bracket such that the mounting formation is a spring-like clip allowing the panel to be clipped on to the bracket, the panel mounts including spaced slots defined in the panel body with a longitudinal lip projecting into each slot so that each slot has a generally L-shaped transverse profile and each lip has a transverse width that is wider than the waist of the mounting formation gap of the mounting formation, to facilitate a frictional fit and thus clipping of the panel mounts into the mounting formations of the brackets.

11. A wall mountable storage arrangement as claimed in claim 7, which includes a storage accessory that is mountable onto a front of the storage panel, which defines longitudinally extending front carrier formations for engaging complementary formations of the storage accessories.

12. A kit for a wall mountable storage arrangement, the kit comprising:
a number of mounting components as claimed in claim 1; and
at least one storage panel for mounting on the mounting components to span the mounting components such that the, or each storage panel is substantially horizontal.

13. A kit as claimed in claim 12 which includes at least one storage accessory for mounting on the storage panel.

14. A method of assembling a wall mountable storage arrangement on a wall, the method comprising the steps of:
fastening a number of mounting components, as claimed in claim 1, to the wall in a spaced, vertical manner; and
mounting at least one storage panel to the mounting components such that the storage panel spans the mounting components.
